(19) United States
(12) Patent Application Publication
(10) Pub. No.: US 2002/0096340 A1
(43) Pub. Date: Jul. 25, 2002

(54) Device for performing safety functions in areas with high frequency radiation

(75) Inventors: Bernd Ondruschka, Leipzig (DE); Matthias Nuchter, Leipzig (DE); Werner Lautenschlager, Leutkirch (DE)

Correspondence Address: FITZPATRICK CELLA HARPER & SCINTO, 30 ROCKEFELLER PLAZA, NEW YORK, NY, 10112, US

(73) Assignee: MLS MIKROWELLEN-LABOR-SYSTEME GMBH, LEUTKIRCH (DE)

(21) Appl. No.: 10/050,783

(22) Filed: Jan. 18, 2002

(30) Foreign Application Priority Data
Jan. 25, 2001 (DE) 101 04 320

(51) Int. Cl. A62C 37/00

(52) U.S. Cl. 169/56

(57) ABSTRACT

1. Device for performing safety functions in areas with high frequency radiation.

2.1. The object was to create a device that reacts to abnormal operating states with inadmissible heating and fire hazard in screened and inaccessible areas with high frequency radiation, in order to perform safety functions of the processing device and to largely prevent or keep within limits damage to this and the substances treated.

2.2. According to the invention in the area with high frequency radiation, at least one sensor that does not react to and does not affect the high frequency radiation is arranged to detect process-critical states such as excess temperatures, which is connected with an already known safety device such as a cooling unit with inert gases or a fire extinguishing system.

2.3. The invention allows advantageous detection and removal of hazards when working in areas with high frequency radiation.

The invention concerns a device for performing safety functions in areas with high frequency radiation.

It allows the advantageous detection and removal of hazards when working in areas in which preferably a specified high frequency radiation is used.

For the running, acceleration and/or initiation of chemical reactions and processes an introduction of energy is often needed. For this purpose the reaction mixtures are arranged in a microwave system with a radiation-screened housing in, for example, reaction containers that allow microwaves to pass through them, and energy is introduced through radiation with microwaves. Since with the reactions and processes that take place high pressures often result or the reactions only run under pressure, the entire arrangement must be stable under pressure and, for example, have a locking cover system. As a result in the event of an incident as a rule no access can be gained to the source of the danger in order, for example in the event of fire, explosion and so on, to be able to influence the extent of any damage. In general the reaction vessels are also fitted with safety and control devices, in order to be able to monitor the running of the chemical reactions and processes.

To date, safety devices in areas subject to high frequency energy have been limited merely to the acquisition of process parameters such as pressure and temperature, directly in or on the reactor (for example: DE 19 70 04 99 A1, DE 19 74 85 20 A1). These sensors control the supply of energy to the system. Apart from this sensors are used for detecting escapes of organic solvents (U.S. Pat. No. 6,033,912), which in the event of leaks in the reactor system cut off the energy supply in order to reduce the explosion hazard but do not remove the danger.

In conventional reactor systems and chemical plants, state of the art fire-fighting equipment in a variety of designs has been known for a long time. Here systems that are based either on inert gases (CO₂ extinguishing agents, for example EP 1 043 045 A2) or also powder- and liquid-based solvents (for example U.S. Pat. No. 5,996,699, WO 00/12177) are used. Here the type of extinguishing agent is determined by the type of combustible or fire-hazard substance.

For large area fire-fighting sprinkler or gassing systems are often used (for example EP 0 046 378, EP 0 801 962, U.S. Pat. No. 5,415,239).

Where fire extinguishing systems are used in the presence of high frequency radiation, apart from the inaccessibility of the point of danger, it is also necessary to take into account the fact that no materials that react with the high frequencies, such as metals and dipolar organic substances, can be introduced into the hazard area. Thus entry by humans is also subject to limits. Because of the well-known effects of high frequency fields and their interaction with living things, polar compounds and metals, the use of conventional safety devices such as fire extinguishers is excluded.

In previous conventional laboratory systems with reactor volumes of below 500 ml and predominantly discontinuous reaction running, the extent of any damage is relatively limited. This aspect is more critical, however, in larger systems and in particular in continuous reaction running. In these reaction areas significantly larger quantities of substances are subject for longer operating times (often unsupervised ongoing trials) to the effect of the high frequency radiation, with hazards such as overheating, explosion of the resultant substances or detonations, increasing accordingly.

The object of the invention is to create a device that reacts to abnormal operating states with inadmissible overheating and fire hazard in screened and inaccessible areas with high frequency radiation, in order to perform safety functions of the treatment device and to largely prevent or keep within limits damage to this and the substances treated.

The object is achieved according to the invention by a sealed and pressurised tube that projects into the high frequency sample chamber (for example in the area of the so-called rotating field distributor). The tube, or the sealed tube end of this, or a plastic block, comprises a plastic that allows high frequencies to pass through and has a low melting temperature (for example polyethylene). In the event of an abnormal operating temperature in this zone, such as occurs in particular when there is a fire or carbonisation process, the plastic, or at least part of it, melts causing the tube that has become unretentive to release the pressure. With this release the cooling or extinguishing process is directly or indirectly triggered. In a possible embodiment of the device according to the invention, the tube is pressurised directly by the fire extinguishing agent, such as CO₂, which when the pressure is released then pours over the hazard point. On the other hand, the said drop in pressure in the tube that has become unretentive can also trigger a pressure sensor (valve) for activation of the fire extinguishing or cooling function.

With the device according to the invention, it is possible to use safety devices that have been known for a long time such as fire extinguishing and cooling systems, to perform safety functions in areas under high frequency radiation that are hermetically sealed and inaccessible because of the necessary protection.

The invention is further explained in the following using embodiments shown in the drawing.

These drawings ate as follows:

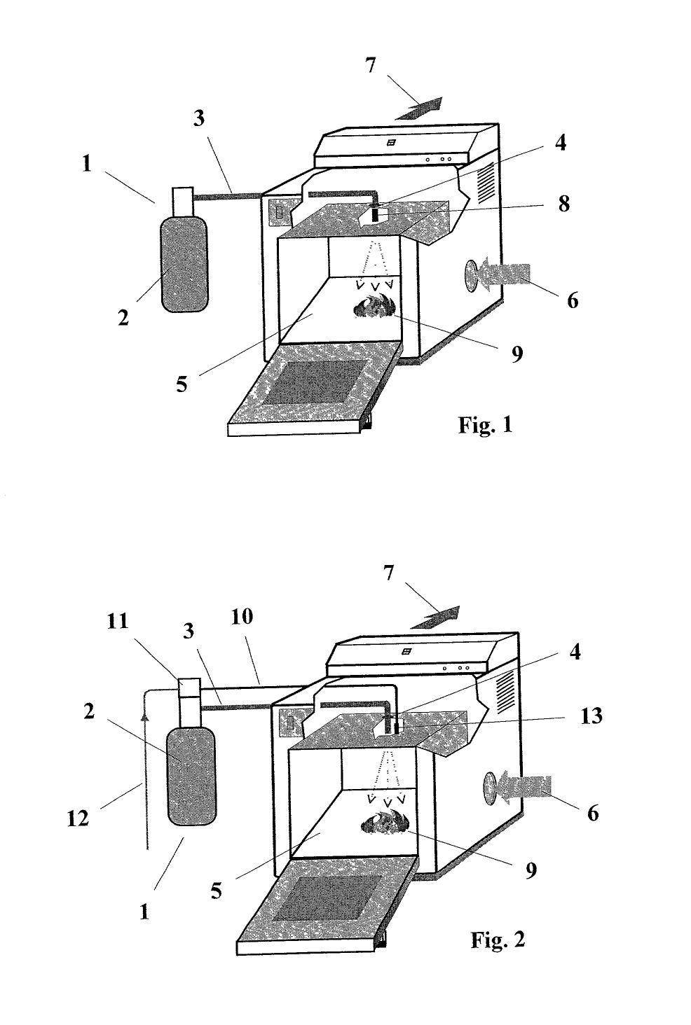

FIG. 1: Basic structure of the device in accordance with the invention, whereby a temperature-sensitive pressure line serves simultaneously as a functional line for introduction of an extinguishing agent of a fire extinguishing system.

FIG. 2: Basic structure of the device in accordance with the invention, whereby a temperature-sensitive, pressurised indicator line is connected via a pressure-operated valve with a fire extinguishing system.

As a safety device an already known fire extinguishing system 1, is provided with a solvent 2, such as pressurised CO₂ (extinguishing gas) and arranged externally to a microwave treatment system. This fire extinguishing system 1 is connected in FIG. 1 with an extinguishing line 3 that is pressurised with the extinguishing gas 2, and which is run over a flange 4 into a'sample chamber 5 of the microwave treatment system, which in a known manner has an air intake 6 and extraction 7. The extinguishing line 3 terminates in a pressure-resistant plastic pipe 8, which protrudes into the sample chamber 5. The plastic pipe 8 comprises a material (such as polyethylene, polypropylene, polystyrene or combinations of these and other plastics), that allows microwave radiation to pass through without significant heating and whose melting temperature is only slightly higher than the operationally permitted limiting temperature in the sample chamber 5 specific to the treatment in the event of an abnormally high operating temperature in the sample chamber 5, in particular in the event of a fire 9 or detonation, the temperature-sensitive material of the plastic pipe 8 melts and it loses its pressure-resistance. Because of this the plastic pipe 8 is now destroyed due to the constant pressure exerted internally upon it and releases the extinguishing agent 2 from the fire extinguishing system 1 via the now open extinguishing line 3 into the sample chamber 5 (shown symbolically with arrows).

In FIG. 2 an indicator line 10 projecting into the sample chamber 5 of the microwave processing system is arranged separately from the extinguisher line 3. The extinguisher line 3 is run as in FIG. 1 via the flange 4 into the sample chamber 5, but terminates as an open line for introduction of the extinguishing agent 2. Unlike the first embodiment, the extinguisher line 3 of the fire extinguishing system 1 is not pressurised by the extinguishing agent 2, but is decoupled from the extinguishing agent 2 via a pressure valve 11 that under normal operating conditions of the microwave treatment system is closed. The pressure valve II is locked by a pressure line 12, via which the indicator line, 10 which is likewise connected to the pressure valve 11, is pressurised.

The other end of the pressurised indicator line 10 projecting into the sample chamber 5 terminates in a plastic pipe 13 which likewise (like the plastic pipe 8 in FIG. 1) comprises a microwave-transparent plastic (such as polyethylene, polypropylene, polystyrene or a combination of these and other plastics) and which in the sample chamber 5 has the same function of temperature indicator as the plastic pipe 8. In the event of abnormal operational heating of the plastic, this melts and releases the pressure within the indicator line 10, the other end of which is connected to the pressure valve 11. This drop in pressure in the indicator line 10 releases the pressure valve 11, which activates the fire extinguishing system 1, so that the extinguishing agent 2 is released and flows via the extinguishing line 3 into the sample chamber 5.

An advantage of this embodiment is that the pressure valve 11 can also be connected to other sensors (for clarity of the drawing not shown in this), such as pressure, temperature and humidity sensors, for monitoring of safety and/or process conditions.

Furthermore, the device according to the invention is not restricted to the incident mentioned but can, inter alia, be used for controlled cooling of samples in the treatment process. Instead of the fire extinguishing system 1 with the extinguishing agent 2, for example, a cooling system (not explicitly shown in the drawing) with a suitable coolant that works on the treatment process of the microwave treatment system can be present and, as described, can be triggered according to the temperature via the pressurised indicator line 10.

### List of Legends

1—Fire extinguishing system

2—Extinguishing agent

3—Extinguishing line

4—Flange

5—Specimen area

6—Air inlet

7—Extraction

8, 13—Plastic pipe

9—Fire

10—Indicator line

11—Pressure valve

12—Pressure line

1. Device for performing safety functions in areas with high frequency radiation, such as in the sample chamber of a microwave treatment system, in which substances are exposed to the effect of one or more high frequency fields, characterised in that in the chamber (5) with high frequency radiation, at least one sensor (8, 13) that does not react to and does not affect the high frequency radiation is arranged to detect process-critical states such as excess temperatures, which is connected with an already known safety device such as a fire extinguishing system (1) or a cooling unit with inert gases.

2. Device according to claim 1, characterised in that the sensor (8, 13) for temperature detection is designed as a pressure line (3 or 10) that allows high frequencies to pass through it and that is located in the chamber (5) or protrudes into it with a seal (8, 13) that is pressure-stable and likewise allows high frequencies to pass through it and has a low melting temperature.

3. Device according to claim 2, characterised in that the pressure-stable seal (8, 13) that allows high frequencies to pass through it, comprises plastic, for example polyethylene, polypropylene, polystyrene or a combination of these and other plastics.

4. Device according to claim 2, characterised in that the pressure line (3 or 10) is run into the chamber (5) as a rigid pipe.

5. Device according to claim 2, characterised in that the pressure line (3 or 5) is run into the chamber as a flexible pipe or tube.

6. Device according to claim 2, characterised in that the pressure line is at the same time envisaged as a functional element of the safety device, such as a pressurised line (3) of a fire extinguishing system (1) for carrying an already known extinguishing agent (2).

7. Device according to claim 2, characterised in that the pressure line (10) is designed independently of the functional element of the safety device (1), and is connected to a pressure-sensitive controller, such as a pressure valve (11) for activation of the safety device (1).

8. Device according to claim 7, characterised in that the pressure-sensitive controller (11) is also connected with other, already known, sensors such as pressure, temperature and humidity sensors, for monitoring of safety and/or process conditions.
